(19) United States
(12) Patent Application Publication
(10) Pub. No.: US 2026/0104876 A1
(43) Pub. Date: Apr. 16, 2026

(54) END-TO-END SERVICE PACKAGE DEPLOYMENT SYSTEM FOR CLOUD-NATIVE NETWORKS

(71) Applicant: DISH Wireless L.L.C., Englewood, CO (US)

(72) Inventors: Darshit Gandhi, Englewood, CO (US); Aakash Agrawal, Englewood, CO (US)

(21) Appl. No.: 18/915,123

(22) Filed: Oct. 14, 2024

(51) Int. Cl. G06F 8/61

(52) U.S. Cl. CPC G06F 8/61

(57) ABSTRACT

Technologies for implementing end-to-end (E2E) package deployment systems for cloud-native networks are described. One method includes receiving, from a user device associated with a user, a selection of at least one base service associated with a network, receiving a selection of at least one customized service for the user, generating, using at least one artificial intelligence (AI) tool, a package for the user, and deploying the package for the user.

### BACKGROUND

A computer system can include a network of computing devices. Examples of computing devices include client devices, such as laptops, desktops, tablets, mobile devices, smartphones, Internet of Things (IoT) devices, etc. Some networks are cloud-native networks. A cloud-native network is a networking approach that is designed to operate efficiently in cloud computing environments. Cloud-native networking approaches can take advantage of the scalability, flexibility, and resilience of cloud infrastructure to provide automated and secure networking services.

More specifically, a cloud-native network can be defined and managed through software (“software-defined approach”), in which network functions like routing, switching, load balancing, firewalls, etc. are deployed and implemented as software. Deploying can include storing an executable file or package in a user account (e.g., cloud storage account), executing the executable file or package, and/or deploying the executable file or package to a user directly. Such a software-defined approach to network functions can allow for programmability and automation of network functions and operations. Cloud-native networks can be controlled and configured through application programming interfaces (APIs) to enable seamless integration with cloud management platforms. Network functions can be virtualized to enable multiple networks to be implemented on top of a shared physical infrastructure. Networking applications can be packaged in containers, making them portable and easy to deploy using a container orchestration system (e.g., Kubernetes). Networking services can be divided up into smaller, independent services (“microservices”) that can be developed, deployed, and scaled independently. Cloud-native networks can be designed with security features, such as encryption, access control, and segmentation. One example of a cloud-native network is a telecommunications network that implements virtualized telecommunications network functions.

Cloud-native networks can provide benefits as compared to traditional hardware networking approaches. For example, cloud-native networks can more easily scale up or down to meet changing workload demands, to help ensure peak performance and cost-efficiency. As another example, automating network functions and operations through software-defined configurations and/or APIs can reduce manual intervention and increase efficiency. As yet another example, cloud-native networks can provide more robust security features to protect against threats.

### BRIEF DESCRIPTION OF THE SEVERAL VIEWS OF THE DRAWINGS

The present disclosure is illustrated by way of example, and not by way of limitation, in the figures of the accompanying drawings.

FIGS. 1A-1B are block diagrams of example systems for implementing an end-to-end (E2E) package deployment system for a cloud-native network, according to some embodiments.

FIG. 2A is a block diagram of example base services that can be selected to implement an end-to-end (E2E) package deployment system for a cloud-native network, according to some embodiments.

FIG. 2B is a block diagram of example customized services that can be selected to implement an end-to-end (E2E) package deployment system for a cloud-native network, according to some embodiments.

FIG. 3 is a block diagram of an example flow that can be used to generate a package, according to some embodiments.

FIG. 4 is a diagram of an example knowledge graph, according to some embodiments.

FIG. 5 is a flow diagram of an example method for implementing an end-to-end (E2E) package deployment system for a cloud-native network, according to some embodiments.

FIG. 6 depicts a 5G network, according to some embodiments.

FIG. 7 depicts a radio access network and a core network for providing a communications channel (or channel) between user equipment and a data network, according to some embodiments.

FIGS. 8A-8B depict a radio access network, according to some embodiments.

### DETAILED DESCRIPTION

Technologies for implementing end-to-end (E2E) package deployment systems for cloud-native networks are described. Examples of packages include application packages, service packages, etc. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular embodiments may vary from these exemplary details and still be contemplated to be within the scope of the present disclosure.

The volume of data generated by a system implementing a cloud-native network can be substantial. Centralizing data and computing resources can also be cost-intensive and can present considerable logistical challenges. As the complexity of a system implementing a cloud-native network increases and additional components are integrated into the cloud-native network, the challenges of service integration, deployment and maintenance can become more pronounced. For example, multiple types of software may need to be deployed, where each type of software can provide compatibility with respect to a particular vendor. Moreover, enabling customization across various network configurations can further add to these challenges. Accordingly, complexity in service management within a cloud-native network can result in deployment delays and frequent disruptions in service pipelines.

Aspects and embodiments of the present disclosure address these challenges by implementing E2E package (e.g., application package or service package) deployment systems for cloud-native networks. An E2E package deployment system described herein can be an automated (e.g., fully automated) E2E solution for integrating and deploying services to respective user accounts (e.g., individual user accounts and/or enterprise user accounts). An E2E package deployment system described herein can allow a user, such as a data developer (e.g., data engineer, data analysis or data scientist) or system administrator (“admin”), to select a combination of services to be packaged into a package to be deployed for the user within a cloud-native network.

One or more services that can be selected by a user can include a base service. A base service is a service that is generically applicable to all users of a cloud-native network (e.g., not a user-specific service). Examples of base services include a device registration service to register devices onto the cloud-native network, a test simulation service to run one or more test simulations for the devices with respect to one or more scenarios, and a network simulation service to run one or more network simulations with respect to one or more scenarios.

One or more services that can be selected by a user can include a customized service. A customized service is a service that is tailored to a particular user of a cloud-native network (e.g., a user-specific service). Examples of customized services include a data quality service, an extract, transform, load (ETL) service, an artificial intelligence (AI) service, and a knowledge graph generation service. For example, ETL can be on-the-fly ETL (OTFETL). OTFETL refers to the process of transforming and processing data in real-time (or near real-time), as it is being extracted from a source system, without storing the data in a temporary location. That is, data flows directly from the source of the data to a target, which simplifies the ETL process and reduces storage requirements. OTFETL can be used for various use cases, such as real-time analytics (e.g., enabling real-time dashboards, reports and/or analytics), real-time data streaming (e.g., processing sensor data or log data), cloud data integration for integrating cloud-based applications and services, data processing for training machine learning models, etc.

The AI service can implement one or more machine learning models (e.g., generative AI models) to assess system requirements, assess validation of inputs and outputs, and/or assess generation of downloadable files and/or packages to be deployed.

A knowledge graph is a graphical representation of knowledge that connects entities, concepts, and relationships. A knowledge graph is a visual and machine-readable way to organize and store information, making it easy to query, analyze, and draw insights. For example, a knowledge graph of a cloud-native network can include nodes representing applications of the cloud-native network (e.g., services, inputs, outputs, inlets, outlets, provisioned services, and transformations), and edges connecting pairs of applications representing relationships or associations (e.g., connections between services and respective inputs, outputs, inlets, outlets, provisioned services, and transformations). The knowledge graph generation service can generate a personalized knowledge graph customized for a user and/or a use case. The knowledge graph can be updated in response to identifying a new service and/or a new service is selected. In some embodiments, the personalized knowledge graph is a subgraph of a previously created knowledge graph for the cloud-native network. More specifically, the subgraph removes nodes and edges that are not necessary for generating the package.

Moreover, an E2E package deployment system described herein can integrate data collection, knowledge graph creation for services and tools, an artificial intelligence (AI) service driven by AI and/or machine learning (e.g., generative AI) to assess system requirements and/or validation of inputs and outputs, and generation of downloadable files or packages to be deployed.

Illustratively, a user, such as a data developer (e.g., data engineer, data analyst or data scientist) or administrator, can use an E2E package deployment system described herein to select one or more services and eliminate the need to identify inputs and outputs, configuration requirements and deployment. The knowledge graph can enable the user to understand system requirements and data flow. The user can use the AI service to intelligently identify integration requirements, such as inlets, outlets, permissions, roles, etc., and dependencies based on the one or more selected services, which can reduce overhead and latency in the provisioning of the one or more services.

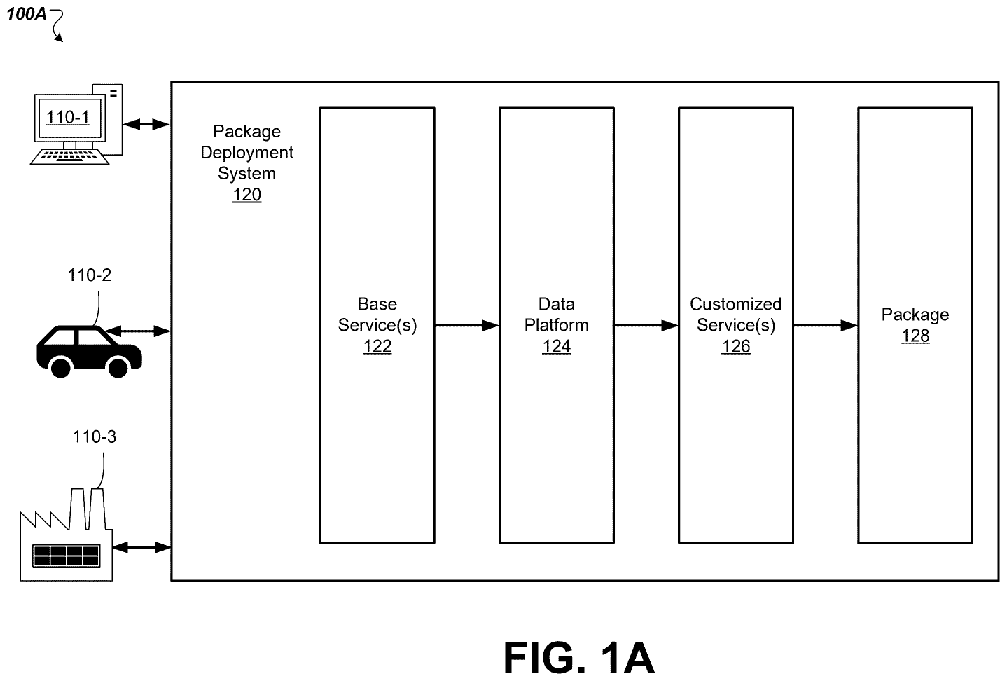

In some embodiments, a cloud-native network is a telecommunications network (e.g., a cellular network). For example, the telecommunications network can include a radio access network (RAN) that can enable communication with user equipment (UE). In particular, UE can communicate with a base station of the RAN. In a fifth generation (5G) wireless network (referred to as a “5G network”), the base station is referred to as a Next Generation Node B, a “gNodeB,” or a “gNB.” A radio unit (RU) is a component of a telecommunication network (e.g., of the RAN) that can transmit and receive radio signals to facilitate communication between the RAN and the UE. For example, an RU can convert digital baseband signals into radio frequency (RF) signals, and transmit the RF signals to UE. As another example, an RU can receive RF signals to UE, and convert the RF signals into digital baseband signals. Examples of RUs include multiple-input multiple-output (MIMO) RUs, small cell RUs, integrated RUs, etc. For example, multiple types of software may need to be deployed to various components of the telecommunications network (e.g., the RU), where each type of software can provide compatibility with respect to a particular vendor. The E2E package deployment system can streamline the generation and deployment of a package that combines the multiple types of software. Further details regarding implementing E2E package deployment systems for cloud-native networks will now be described below with reference to FIGS. 1A-8B.

FIG. 1A is a diagram of an example system (e.g., network) 100A for implementing an end-to-end package deployment system for a cloud-native network, according to some embodiments. In some embodiments, the cloud-native network is a telecommunications network (e.g., a cellular network). An example of a telecommunications network will be described below with reference to FIG. 1B. However, the type of cloud-native network should not be considered limiting.

As shown, the system 100A can include multiple data sources, including data sources 110-1 through 110-3. In this illustrative example, the data source 110-1 is shown as a client device, the data source 110-2 is shown as an automobile, which can include client devices, and the data source 110-3 is shown as a manufacturing site, which can include client devices (e.g., a factory). Examples of client devices include laptops, desktops, tablets, mobile devices, smartphones, IoT devices, etc.

The system 100A can further include a package deployment system (“system”) 120. The system 120 can be used to generate and deploy packages for respective users (e.g., user accounts).

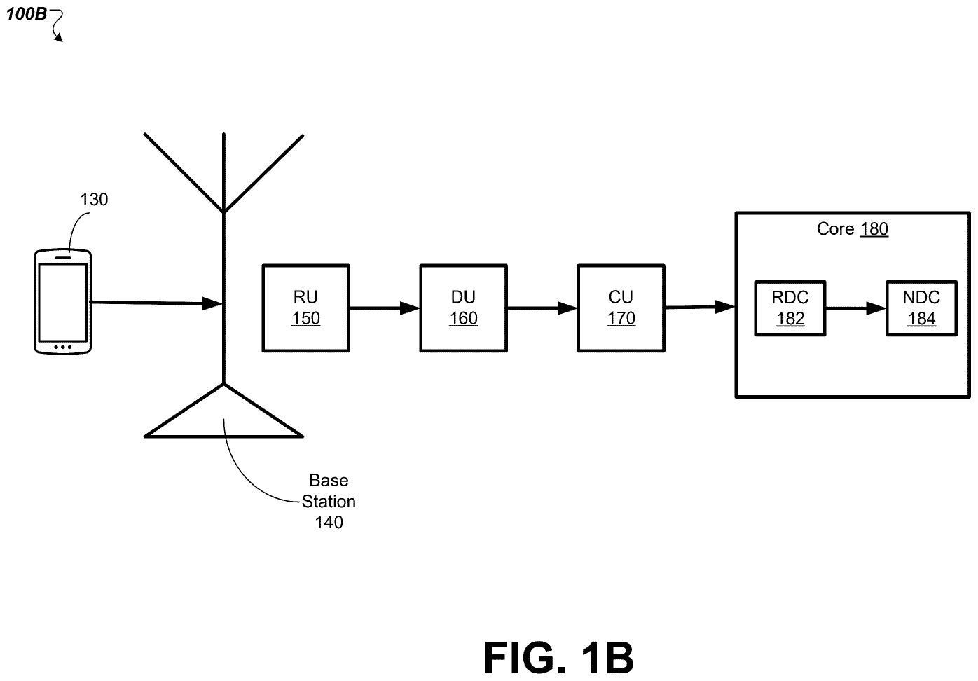

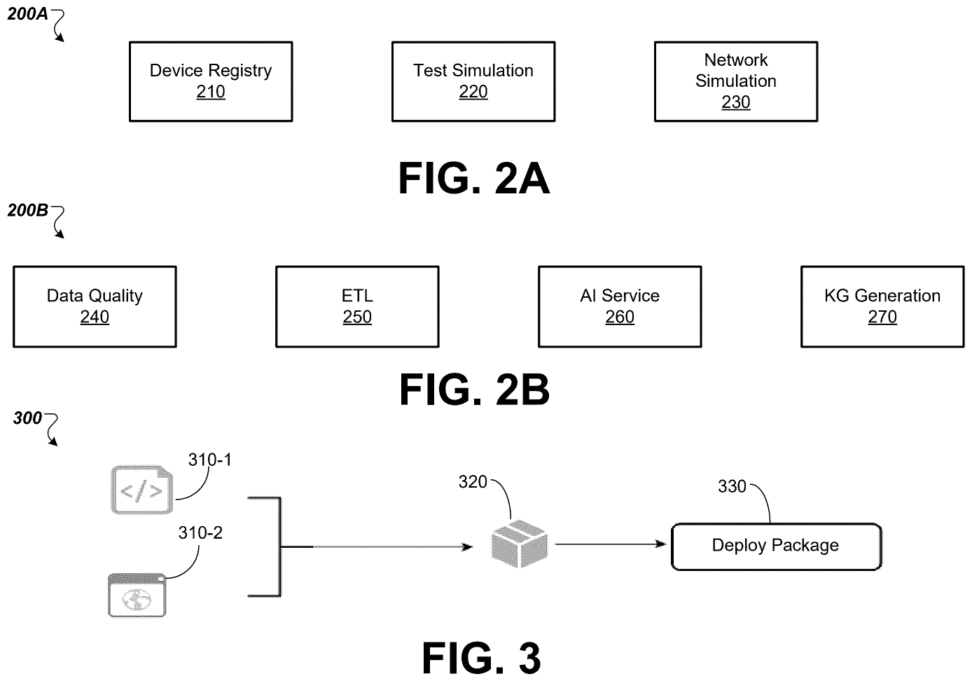

For example, the system 120 can receive a selection of one or more base services (“base service(s)”) 122. For example, the selection of the base service(s) 122 can be received from a user associated with a user device (e.g., user device 110-1, 110-2 or 110-3) (e.g., via a UI). A base service is a service that is generically applicable to all users of a cloud-native network (e.g., not a user-specific service). Examples of base services that can be selected by a user will now be described below with reference to FIG. 2A.

FIG. 2A is a block diagram of example base services 200A that can be selected to implement an end-to-end package deployment system for a cloud-native network, according to some embodiments. For example, one or more of the base services 200A can correspond to the base service(s) 122 of FIG. 1A.

As shown, the base services 200A can include a device registry service 210. The device registry service 210 can be used to register one or more user devices within the system 100.

The base services 200A can further include a test simulation service 220. The test simulation service 220 can be used to run test simulations for a user device with respect to various scenarios. Examples of simulations include test simulations and/or network simulations.

The base services 200A can further include a network simulation service 230. The network simulation service 230 can be used to run one or more network simulations with respect to one or more scenarios.

Referring back to FIG. 1A, in some embodiments, the system 120 receives a selection of a data platform 124 to be enabled. For example, the selection of the data platform selection can be received from the user (e.g., via the UI). The data platform 124 can include a set of tools that enable the collection, storage, processing, and analysis of large amounts of data from various sources. The data platform 124 can support various data formats, sources, and processing engines. For example, the data platform 124 can include at least one of a data ingestion tool to ingest data from various s, a data storage tool to provide scalable data storage solutions (e.g., at least one of a data lake, data warehouse, a database, etc.) a data processing tool to process the ingested data (e.g., a batch processing tool, a stream processing tool and/or a real-time processing tool), a data analytics tool to analyze the (processed) data (e.g., at least one of a data visualization tool, a machine learning tool, a query engine tool)), a data governance tool for data management and security (e.g., at least one of data cataloging and metadata management, data security and access control, data quality and validation, etc.)

The system 120 can further include a selection of one or more customized services (“customized services”) 126. For example, the selection of the base service(s) 122 can be received from a user associated with a user device (e.g., user device 110-1, 110-2 or 110-3) (e.g., via a UI). A base service is a service that is generically applicable to all users of a cloud-native network (e.g., not a user-specific service). Examples of customized services that can be selected by a user will now be described below with reference to FIG. 2B.

FIG. 2B is a block diagram of example customized services 200B that can be selected to implement an end-to-end package deployment system for a cloud-native network, according to some embodiments. For example, one or more of the customized services 200B can correspond to the customized service(s) 126 of FIG. 1A.

As shown, the customized services 200B can include a data quality service 240.

The customized services 200B further include an ETL service 250. In some embodiments, the ETL service 250 is an OTFETL service.

The customized services 200B can further include an AI service 330. The AI service 330 can implement one or more machine learning models (e.g., generative AI models) to assess system requirements, assess validation of inputs and outputs, and/or assess generation of software, files and/or packages to be deployed.

The customized services 200B can further include a knowledge graph (KG) generation service 270. The KG generation service 270 can generate a personalized KG customized for a user. In some embodiments, the personalized KG is a subgraph of a previously created KG for the cloud-native network.

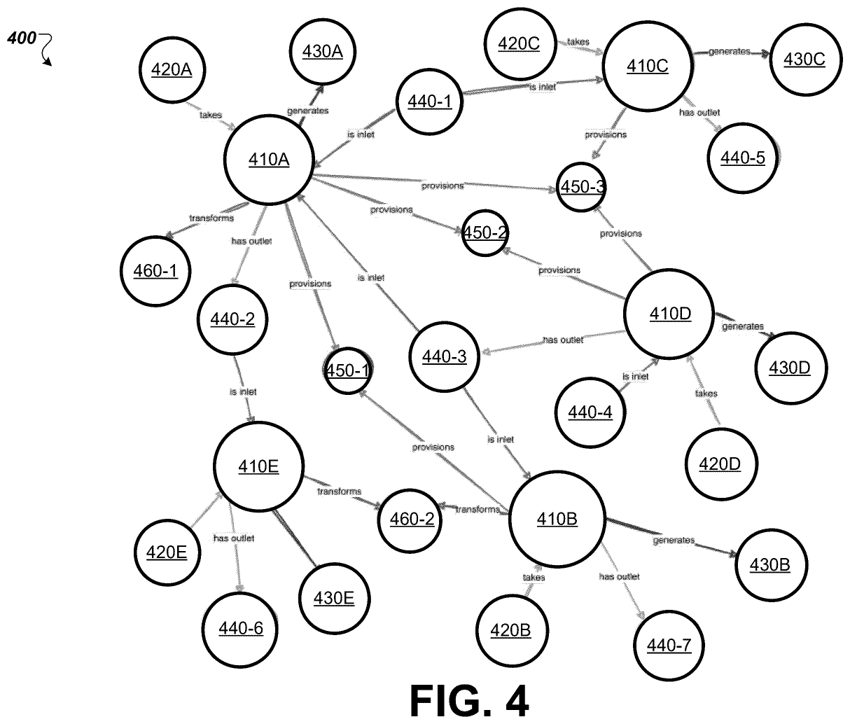

Referring back to FIG. 1A, the system 120 can generate and deploy a package 128 (e.g., deployment files) for the user. More specifically, the package 128 can be generated based on the base service(s) 122 and the customized service(s) 126 selected by the user. The package 128 can be generated using various options, as will now be described below with reference to FIG. 3.

FIG. 3 is a diagram 300 of an example flow that can be used to generate a package, according to some embodiments. As shown, the package can be generated via option 310-1 or option 310-2. Option 310-1 is an Infrastructure as Code (IaC) option. IaC refers to managing and automated provisioning infrastructure resources, such as servers, networks, and storage, through code and configuration or definition files that describe a target infrastructure state, rather than through manual processes or UIs. For example, defining configuration files can include writing the configuration files in a suitable language (e.g. JSON or YAML). Provisioning the configuration files can include using an IaC tool to interpret the configuration files and automatically create, update and/or delete resources to match the target infrastructure state. Managing the configuration files can include modifying the configuration files and re-provisioning the configuration files using the IaC tool. Infrastructure configurations can be stored in version control systems, which can be used to track and version changes to the infrastructure configurations. Infrastructure configurations can be defined in a declarative manner (e.g., specifying resources that are needed, as opposed to how to create the resources). Infrastructure configurations can be consistent across environments, which can reduce errors.

Option 310-2 is a UI option. More specifically, the package creation component can receive, via a UI (e.g., graphical user interface (GUI)), the selection of the services from a user device.

Based on the services that are selected (e.g., via option 310-1 or option 310-2), a package 320 can be generated. For example, the package 320 can correspond to the package 128 of FIG. 1. The package 320 can include a package file. The package 320 can then be deployed, which is represented by block 330. For applications that would benefit for increased security (e.g., “critical” applications), deployment of the package 320 can be restricted only to users who are admins.

FIG. 1B is a diagram of an example system (e.g., network) 100B for implementing an end-to-end package deployment system for a cloud-native network, according to some embodiments. In particular, the cloud-native network is a telecommunications network (e.g., a cellular network). In some embodiments, the telecommunications network is a 5G network. However, the type of cloud-native network and/or telecommunications network should not be considered limiting.

As shown, the system 100B can include at least one user equipment (UE) 130, a base station 140, an RU 150, a distributed unit (DU) 160, a centralized unit (CU) 170 and a core network (“core”) 180. For example, the core 180 can include a regional datacenter (RDC) 182 and a national datacenter (NDC) 184. The RDC 182 can serve a specific geographical region, handling a subset of the core network functions of the core 180 for that area. The RDC 182 can manage signaling processes for subscribers within its geographical region, including authentication, session management, and some aspects of voice services. The RDC 182 can reduce latency by processing data closer to the users (e.g., the UE 130) being served. The NDC 184 can serve as the central hub for the core network functions of the core 180 with respect to the entire telecommunications network. The NDC 184 can include components like the main control plane, subscriber data management, policy control, and other centralized services. The NDC 184 can coordinate with various RDCs (e.g., the RDC 182) to ensure seamless operation and service delivery across the entire telecommunications network.

Software (e.g., applications) can be deployed at various components of the system 100B. For example, software can be deployed at the UE 130, the RU 150, the DU 160, the CU 170, etc. Some of the software may be needed for inter-component communication.

Deploying software at multiple components manually can be a time consuming and cumbersome process. For example, multiple types of software may need to be deployed at one or more of the components, where each type of software can provide compatibility with respect to a particular vendor. To address this, the end-to-end package deployment system described herein can be used to generate a deployable software package that, when executed, can install each type of software at one or more components. For example, an AI service (e.g., the AI service 260 of FIG. 2B) can determine which types of software should be included in the software package to be deployed at the component(s), and can cause the software package to be generated for deployment at the component(s).

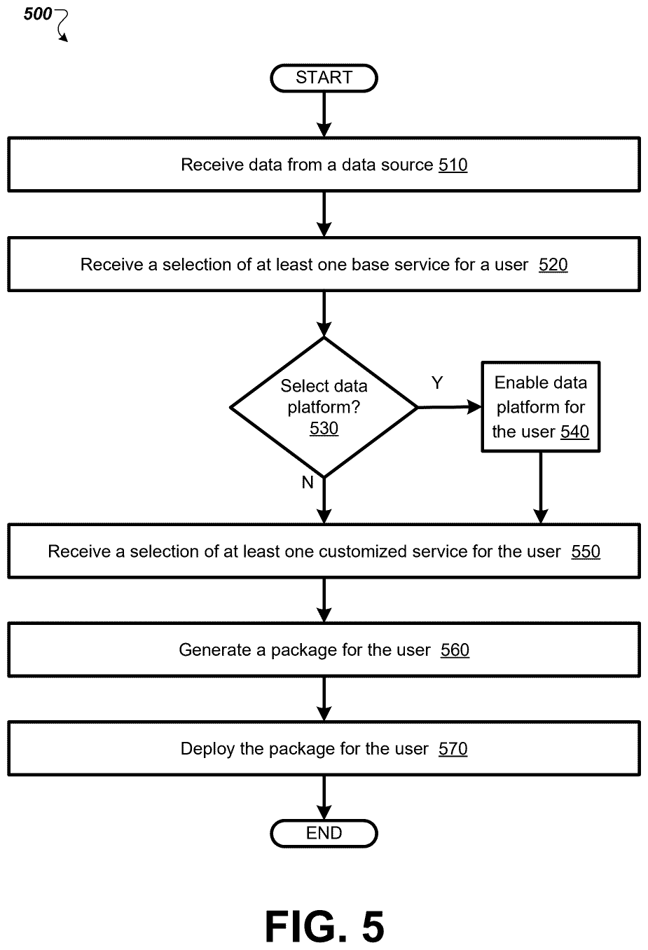

FIG. 4 is a diagram of an example knowledge graph 400, according to some embodiments. The knowledge graph 400 includes service nodes 410A through 410E corresponding to respective services A through E. Other nodes include input nodes 420A through 420E corresponding to respective inputs of the services, output nodes 430A through 430E corresponding to respective outputs of the services, inlet/outlet nodes 440-1 through 440-7 corresponding to respective inlets and/or outlets of the services, provision nodes 450-1 through 450-3 corresponding to respective services provisioned by respective services (if any), and transformation nodes 460-1 and 460-2 corresponding to respective transformations performed by respective services (if any). At each of the service nodes, there is additional infrastructure related information (e.g., tech requirements), such as compute, security (e.g., authentication), permissions or roles, resources, etc.

There are various connections between services A through E. Examples of connections include inlet/outlet connections, transformation connections, provision connections, etc. For example, the outlet of service D also functions as an inlet for service A (represented by inlet/outlet node 440-3), which is how service A and service D are connected. As another example, service A and service B provision the same service (represented by provision node 450-1). As yet another example, service B and service E have the same transformation (represented by transformation node 460-1).

Based on the services that are selected, a subset of the knowledge graph 400 can be created with updated relationships. Based on the metadata, configuration files can be generated (e.g., IaC), which can then be deployed.

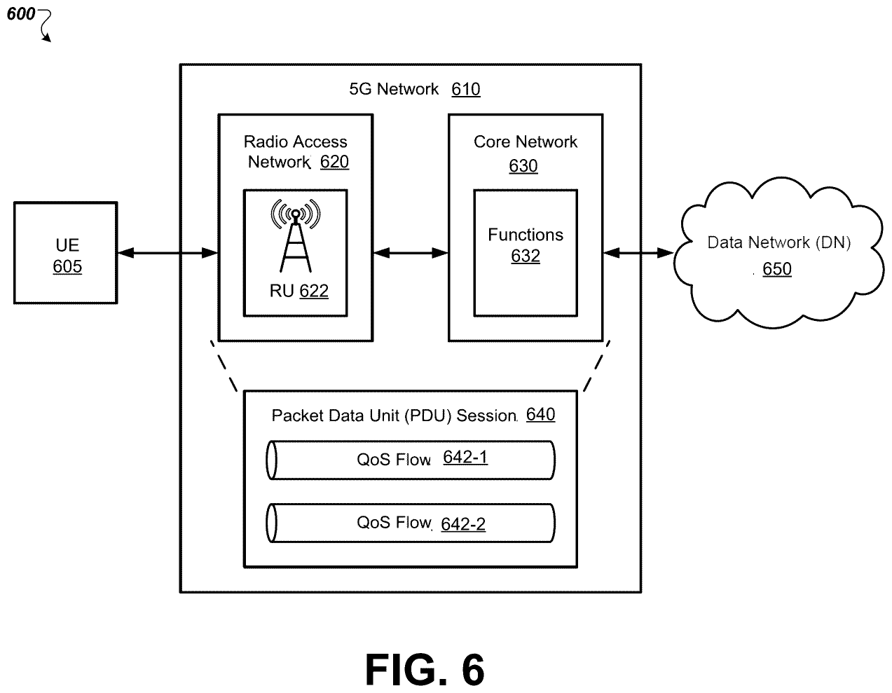

FIG. 5 is a flow diagram of a method 500 for implementing an end-to-end (E2E) package deployment system for a cloud-native network, according to some embodiments. Method 500 may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, method 500 may be performed, in part, by components of system 100. Method 500 may be performed by a guest operator. In some embodiments, a non-transitory machine-readable storage medium stores instructions that when executed by a processing device (e.g., the guest operator) cause the processing device to perform method 500. For simplicity of explanation, method 500 is depicted and described as a series of operations. However, operations in accordance with this disclosure can occur in various orders and/or concurrently and with other operations not presented and described herein. Furthermore, not all illustrated operations may be performed to implement method 500 in accordance with the disclosed subject matter. In addition, those skilled in the art will understand and appreciate that method 500 could alternatively be represented as a series of interrelated states via a state diagram or events.

At operation 510, processing logic receives data from at least one data source.

At operation 520, processing logic receives a selection of at least one base service for a user. Examples of base services include a device registration service to register devices onto the cloud-native network, a test simulation service to run one or more test simulations for the devices with respect to one or more scenarios, and a network simulation service to run one or more network simulations with respect to one or more scenarios.

At operation 530, processing logic determines whether a data platform is selected by the user. If so, processing logic enables the data platform for the user at operation 540.If not, or after the data platform is enabled at operation 540, processing logic receives a selection of at least one customized service at operation 550. For example, at least one customized service can include at least one of: a data quality service, an ETL service, an AI service, or a KG generation service.

At operation 560, processing logic generates a package for the user. For example, the package can include a package file. The package includes the components that are sufficient to execute at least one application or service defined by the package. In some embodiments, the package is generated via IaC. In some embodiments, the package is generated via a UI (e.g., GUI). More specifically, the package creation component can receive, via the UI, the selection of the services from a user device.

At operation 570, processing logic deploys the package for the user. In some embodiments, deployment of the package is automatic. For example, the AI service can automatically deploy the package after the package is generated. In some embodiments, deployment of the package is manual. In some embodiments, deployment of the package is restricted. For example, for applications that would benefit for increased security (e.g., “critical” applications), deployment of the package can be restricted only to users who have personas with deployment privileges (e.g., administrators). Further details regarding operations 510-570 are described above with reference to FIGS. 1A-4.

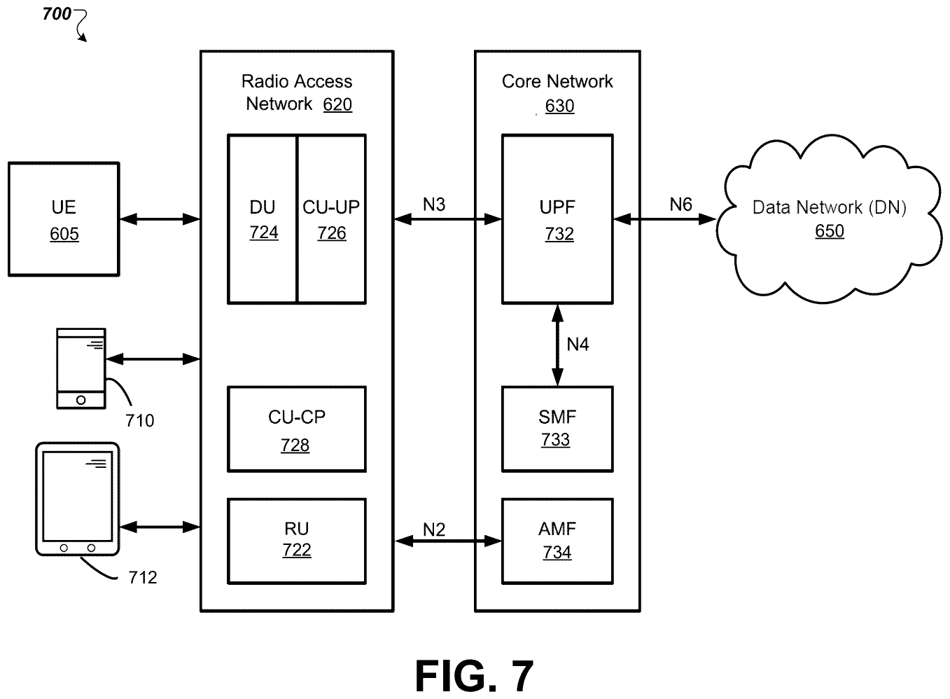

FIG. 6 depicts a system 600 includes a 5G network 610, according to at least one embodiment. The 5G network can include a RAN 620. For example, the RAN 620 can include a new-generation radio access network (NG-RAN) that uses the 5G new radio interface (NR). The 5G network 610 connects a UE 605 to a data network (DN) 650 using the RAN 620 and a core network 630. The DN 650 can include the Internet, a local area network (LAN), a wide area network (WAN), a private data network, a wireless network, a wired network, or a combination of networks. The UE 605 can include an electronic device with wireless connectivity or cellular communication capability, such as a mobile phone or handheld computing device. In at least one example, the UE 605 can include a 5G smartphone or a 5G cellular device that connects to the RAN 620 via a wireless connection.

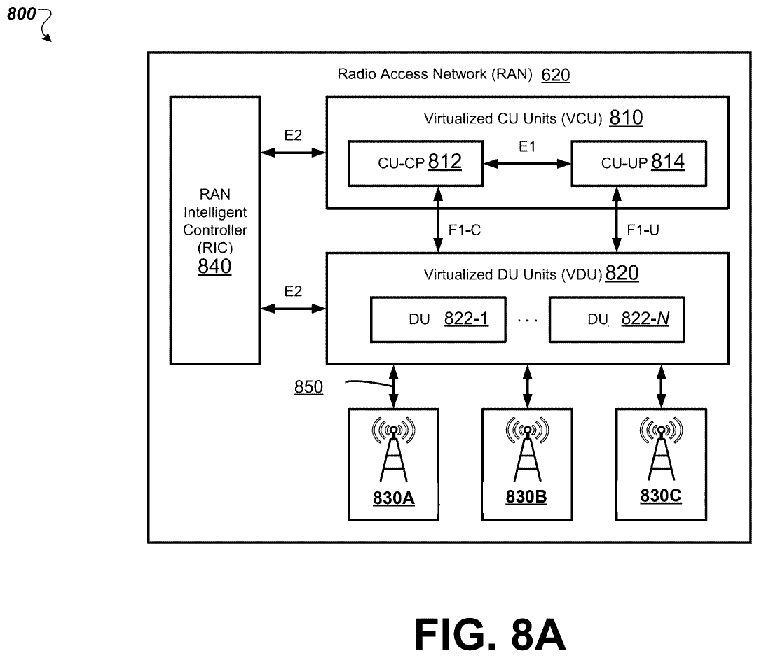

The RAN 620 may include at least one base station that connects the UE 605 to the core network 630. In some embodiments, and as shown in FIG. 6, the at least one resource allocator 170 can be included in the RAN 620. As will be described in further detail below with reference to FIG. 7, the RAN 620 can include at least one radio unit (RU) 622 for wirelessly communicating with the UE 605. The RU 622 can include one or more radio transceivers for wirelessly communicating with UE 605. The RU 622 may include circuitry for converting signals sent to and from an antenna of the base station into digital signals for transmission over packet networks.

The core network 630 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) (e.g., HTTP2) and application programming interfaces (APIs). In at least one embodiment, an architecture in which software is composed of small independent services that communicate over well-defined APIs may be used for implementing some of the core network functions. For example, control plane (CP) network functions for performing session management may be implemented as containerized applications. A container-based embodiment may offer improved scalability and availability over other approaches.

Core network functions (“functions”) 632 of core network can include an access and mobility management function (AMF), a session management function (SMF), and a user plane function (UPF). In at least one embodiment, the intelligent data collector can be implemented in the AMF. The UPF may perform packet processing including routing and forwarding, quality of service (QoS) handling, and packet data unit (PDU) session management. The UPF may serve as an ingress and egress point for user plane traffic and provide anchored mobility support for user equipment. For example, the UPF may provide an anchor point between the UE 605 and the DN 650 as the UE 605 moves between coverage areas. The AMF may act as a single-entry point for UE connection and perform mobility management, registration management, and connection management between a data network and the UE 605. The SMF may perform session management, user plane selection, and internet protocol (IP) address allocation. Functions 632 can include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment. Further details regarding the functions 632 will be described below with reference to FIG. 7.

The 5G network 610 may provide one or more network slices, where each network slice may include a set of network functions that are selected to provide telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 610. In some cases, the 5G network 610 may support customized policy configuration and enforcement between network slices per service level agreements (SLAs) within the RAN 620. User equipment, such as UE 605, may connect to multiple network slices at the same time (e.g., eight different network slices). In one embodiment, a PDU session, such as PDU session 640, may belong to only one network slice instance.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 620, such as a DU and a CU, may need to be deployed at a base station or in a local data center (LDC) that is in close proximity to a base station such that the latency requirements are satisfied (e.g., such that the one-way latency from the base station to the DU component or CU component is less than 1.2 milliseconds (ms)). In some embodiments, the DU and the CU of the RAN 620 may be co-located with the RU. In other embodiments, the DU and the RU may be co-located at a base station and the CU may be located within a local data center (LDC).

In some cases, the 5G network 610 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 630 may include a set of network elements that are configured to offer various data and telecommunications services to subscribers or end users of user equipment, such as UE 605. Examples of network elements include network computers, network processors, networking hardware, networking equipment, routers, switches, hubs, bridges, radio network controllers, gateways, servers, virtualized network functions and/or containerized network functions, and network functions infrastructure (e.g., virtualization or containerization infrastructure). A network element can include a real or virtualized or containerized component that provides wired or wireless communication network services.

Virtualization allows virtual hardware to be created and decoupled from the underlying physical hardware. One example of a virtualized component is a virtual router (or a vRouter). Another example of a virtualized component is a virtual machine. A virtual machine can include a software embodiment of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 610 may implement various network functions, such as the functions 632 and radio access network functions, using a cloud-based compute and storage infrastructure. A network function may be implemented as a software instance running on hardware or as a virtualized network function. Virtual network functions (VNFs) can include embodiments of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G network 610 may connect the UE 605 to the DN 650 using a PDU session 640, which can include part of an overlay network. The PDU session 640 may utilize one or more quality of service (QoS) flows, such as QoS flows 605 and 606, to exchange traffic (e.g., data and voice traffic) between the UE 605 and the DN 650. The one or more QoS flows can include the finest granularity of QoS differentiation within the PDU session 640. The PDU session 640 may belong to a network slice instance through the 5G network 610. To establish user plane connectivity from the UE 605 to the DN 650, an AMF that supports the network slice instance may be selected and a PDU session via the network slice instance may be established. In some cases, the PDU session 640 may be of type IPv4 or IPv6 for transporting IP packets. The RAN 620 may be configured to establish and release parts of the PDU session 640 that cross the radio interface.

The RAN 620 may include a set of one or more RUs that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 605, over a geographic area. Some cells may correspond with stationary coverage areas and other cells may correspond with coverage areas that change over time (e.g., due to movement of a mobile RU). In some cases, the UE 605 may be capable of transmitting signals to and receiving signals from one or more RUs within the network of cells over time. One or more cells may correspond with a base station. The cells within the network of cells may be configured to facilitate communication between UE 605 and other UEs and/or between UE 605 and a data network, such as DN 650. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The UPF may be responsible for routing and forwarding user plane packets between the RAN 620 and the DN 650. Uplink packets arriving from the RAN 620 may use a general packet radio service (GPRS) tunneling protocol (or GTP) to reach the UPF. The GPRS tunneling protocol for the user plane may support multiplexing of traffic from different PDU sessions by tunneling user data over the interface between the RAN 620 and the UPF.

The UPF may remove the packet headers belonging to the GTP tunnel before forwarding the user plane packets towards the DN 650. As the UPF may provide connectivity towards other data networks in addition to the DN 650, the UPF must ensure that the user plane packets are forwarded towards the correct data network. Each GTP tunnel may belong to the PDU session 640. The PDU session 640 may be set up towards a data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the DN 650 are mapped onto at least one quality of service (QoS) flow belonging to the PDU session 640 before forwarded towards the appropriate RAN 620. A QoS flow may correspond with a stream of data packets that have equal QoS. In some embodiments, and as sown in FIG. 6, multiple QoS flows including QoS flow 642-1 and 642-2 can belong to the PDU session 640. The UPF may use a set of service data flow (SDF) templates to map each downlink packet onto a respective QoS flow. The UPF may receive the set of SDF templates from a session management function (SMF), such as the SMF, during setup of the PDU session 640. The SMF may generate the set of SDF templates using information provided from a policy control function (PCF), such as the PCF. The UPF may track various statistics regarding the volume of data transferred by each PDU session, such as PDU session 640, and provide the information to an SMF.

FIG. 7 depicts a system 700 for providing a communications channel (or channel) between the UE 605 and the DN 650, according to some embodiments. The communications channel can include a pathway through which data is communicated between the UE 605 and the DN 650. The UE in communication with the RAN 620 includes UE 605, mobile phone 710, and mobile computing device 712. The UE 605 may include a set of electronic devices, including mobile computing device and non-mobile computing device.

The core network 630 includes core network functions such as UPF 732, SMF 733 and AMF 734, as described above with reference to FIG. 6. For example, the AMF 734 may interface with user equipment and act as a single-entry point for a UE connection. The AMF 734 may interface with the SMF to track user sessions. The AMF 734 may interface with a network slice selection function (NSSF) not depicted to select network slice instances for user equipment, such as UE 605. When user equipment is leaving a first coverage area and entering a second coverage area, the AMF 734 may be responsible for coordinating the handoff between the coverage areas whether the coverage areas are associated with the same radio access network or different radio access networks.

The UPF 732 may transfer downlink data received from the DN 650 to user equipment, such as UE 605, via the RAN 620 and/or transfer uplink data received from user equipment to the DN 650 via the RAN 620. An uplink can include a radio link though which user equipment transmits data and/or control signals to the RAN 620. A downlink can include a radio link through which the RAN 620 transmits data and/or control signals to the user equipment.

The RAN 620 may be logically divided into an RU 722, a distributed unit (DU 724), and a centralized unit (CU) that is partitioned into a CU user plane portion (CU-UP) 726 and a CU control plane portion (CU-CP) 728. The CU-UP 726 may correspond with the centralized unit for the user plane and the CU-CP 728 may correspond with the centralized unit for the control plane. The CU-CP 728 may perform functions related to a control plane, such as connection setup, mobility, and security. The CU-UP 726 may perform functions related to a user plane, such as user data transmission and reception functions.

Decoupling control signaling in the control plane from user plane traffic in the user plane may allow the UPF 732 to be positioned in close proximity to the edge of a network compared with the AMF 734. In at least one embodiment, the intelligent data collector 106 can be implemented in the AMF 734. As a closer geographic or topographic proximity may reduce the electrical distance, this means that the electrical distance from the UPF 732 to the UE 605 may be less than the electrical distance of the AMF 734 to the UE 605. The RAN 620 may be connected to the AMF 734, which may allocate temporary unique identifiers, determine tracking areas, and select appropriate policy control functions (PCFs) for user equipment, via an N2 interface. The N3 Interface may be used for transferring user data (e.g., user plane traffic) from the RAN 620 to the user plane function UPF 732 and may be used for providing low-latency services using edge computing resources. The electrical distance from the UPF 732 (e.g., located at the edge of a network) to user equipment, such as UE 605, may impact the latency and performance services provided to the user equipment. The UE 605 may be connected to the SMF 733 via an N1 interface not depicted, which may transfer UE information directly to the AMF 734. The UPF 732 may be connected to the DN 650 via an N6 interface. The N6 interface may be used for providing connectivity between the UPF 732 and other external or internal data networks (e.g., to the Internet). The RAN 620 may be connected to the SMF 733, which may manage UE context and network handovers between Base Stations, via the N2 interface. The N2 interface may be used for transferring control plane signaling between the RAN 620 and the AMF 734.

The RU 722 may perform physical layer functions, such as employing orthogonal frequency-division multiplexing (OFDM) for downlink data transmission. In some cases, the DU 724 may be located at a base station (or a cellular Base Station) and may provide real-time support for lower layers of the protocol stack, such as the radio link control (RLC) layer and the medium access control (MAC) layer. The CU may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some embodiments, a radio access network may correspond with a single CU that connects to multiple DUs (e.g., 10 DUs), and each DU may connect to multiple RRUs (e.g., 18 RRUs). In this case, a single CU may manage 10 different base stations and 180 different RRUs.

In some embodiments, the RAN 620 or portions of the RAN 620 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 724 and CU-UP 726 may be executed as virtual instances within a data center environment that provides single-digit millisecond latencies (e.g., less than 2 ms) from the virtual instances to the UE 605.

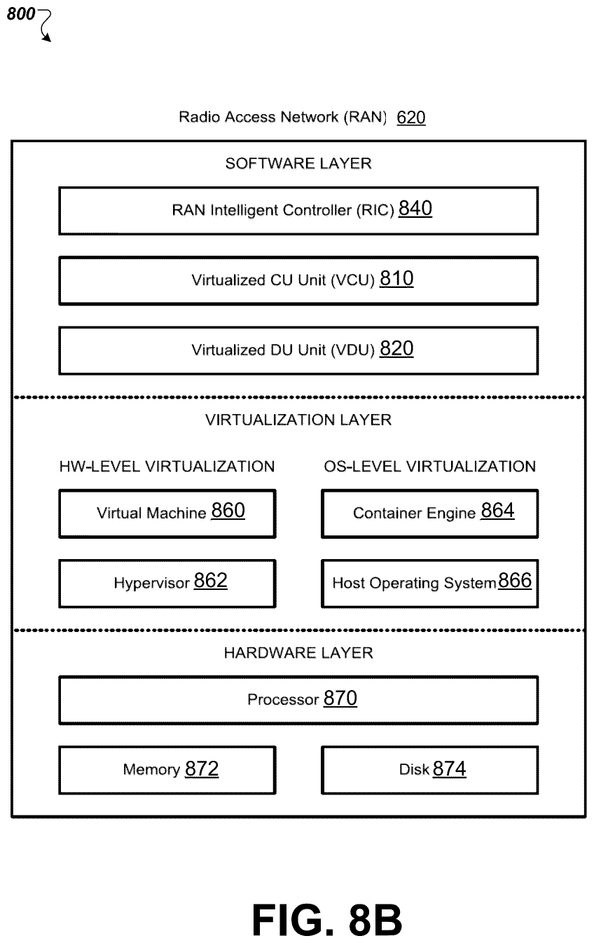

FIG. 8A is a diagram 800 depicting a RAN 620, according to some embodiments. As depicted, the RAN 620 can include virtualized CU units (vCU) 810. The vCU 810 can include virtualized versions (or containerized versions) of CUs, including a CU-CP 812 and a CU-UP 814. In one example, CUs can include a logical node configured to provide functions for the radio resource control (RRC) layer, the packet data convergence control (PDCP) layer, and the service data adaptation protocol (SDAP) layer. The CU-CP 812 can include a logical node configured to provide functions of the control plane part of the RRC and PDCP. The CU-UP 814 can include a logical node configured to provide functions of the user plane part of the SDAP and PDCP. Virtualizing the control plane and user plane functions allows the CUs to be consolidated in one or more data centers on RAN-based open interfaces.

The RAN 620 can further include virtualized DU units (vDU) 820. The vDU 820 can include virtualized versions (or containerized versions) of DUs 822-1 through 822-N. Each DU 822-1 through 822-N can include a logical node configured to provide functions for the radio link control (RLC) layer, the medium access control (MAC) layer, and the physical layer (PHY) layers. For example, a higher physical layer (H-PHY) can reside at the DUs and a lower physical layer (L-PHY) can reside at the RU.

The RUs 830A-830C may correspond with different base stations. A single DU may connect to multiple RUs via a fronthaul interface 850. The fronthaul interface 850 may provide connectivity between DUs and RUs. For example, DU 830A may connect to 18 RUs via the fronthaul interface 850. CUs may control the operation of multiple DUs via a midhaul F1 Interface that includes the F1-C and F1-U interfaces. The F1 Interface may support control plane and user plane separation, and separate the Radio Network Layer and the Transport Network Layer. In one example, the CU-CP 812 may connect to ten different DUs within the virtualized DU units 1210. In this case, the CU-CP 812 may control ten DUs and 180 RUs. A single one of DUs 822-1 through 822-N may be located at a base station or in a local data center. Centralizing a single DU at a local data center or at a single base station location instead of distributing the single DU 1204 across multiple base stations may result in reduced costs.

The CU-CP 812 may host the radio resource control (RRC) layer and the control plane part of the packet data convergence control (PDCP) layer. The E1 Interface may separate the Radio Network Layer and the Transport Network Layer. The CU-CP 812 terminates the E1 Interface connected with the centralized unit for the user plane CU-UP 814 and the F1-C interface connected with the DUs 822-1 through 822-N. The CU-UP 814 hosts the user plane part of the PDCP layer and a service data adaptation protocol (SDAP) layer. The CU-UP 814 terminates the E1 Interface connected with the centralized unit for the CU-CP 812 and the F1-U interface connected with the DUs 822-1 through 822-N. The DUs 822-1 through 822-N may handle the lower layers of the baseband processing up through the PDCP layer of the protocol stack. The interfaces F1-C and E1 may carry signaling information for setting up, modifying, relocating, and/or releasing a UE context.

In some embodiments, and as shown in FIG. 8A, the RAN 620 includes a RAN intelligent controller (RIC) 840. The RIC 840 may control the underlying RAN elements via the E2 Interface. The E2 Interface connects the RIC 840 to the DUs 822-1 through 822-N and the centralized units including CU-CP 812 and CU-UP 814. The RIC 840 can include a real time or near-real time RIC (RT-RIC) or a non-real-time RIC (NRT-RIC). An NRT-RIC can include a logical node allowing non-real time control rather than near-real-time control and an RT-RIC can include a logical node allowing near-real-time control and optimization of RAN elements and resources on the bases of information collected from the DUs 822-1 through 822-N and the centralized units including CU-CP 812 and CU-UP 814 via the E2 Interface.

The virtualization or containerization of the DUs 822-1 through 822-N and the centralized units including CU-CP 812 and CU-UP 814 allows various deployment options that may be adjusted over time based on network conditions and network slice requirements. In at least one example, both a DU and a corresponding centralized unit may be implemented at a base station. In another example, at least one DUs 822-1 through 822-N may be implemented at a base station and the corresponding CU-UP 814 may be implemented at a local data center (LDC). In another example, at least one DUs 822-1 through 822-N and the corresponding CU-UP 814 may be implemented at an LDC. In another example, at least one DUs 822-1 through 822-N and the corresponding CU-UP 814 may be implemented at a base station, but the corresponding the CU-CP 812 may be implemented at an LDC. In another example, at least one DUs 822-1 through 822-N may be implemented at an LDC and the corresponding CU-CP 812 and CU-UP 814 may be implemented at an EDC.

In some embodiments, network slicing operations may be communicated via the E1, F1-C, and F1-U interfaces of the RAN 620. For example, CU-CP 812 may select the appropriate DU and CU-UP 814 entities to serve a network slicing request associated with a particular service level agreement (SLA).

FIG. 8B depicts a RAN 620, according to at some embodiments. As depicted, the RAN 620 can include a software layer, a virtualization layer and a hardware layer. The software layer can include vCU 810, vDU 820 and RIC 840, as described above with reference to FIG. 8A.

The RAN 620 can include a virtualization layer including at least one virtual machine 860, a hypervisor 862, container engine 864, and a host operating system 866. The hypervisor 862 can include a native hypervisor (or bare-metal hypervisor) or a hosted hypervisor (or type 2 hypervisor). The hypervisor 862 may provide a virtual operating platform for running at least one virtual machine 860. The hypervisor 862 can include software that creates and runs virtual machine instances. The at least one virtual machine 860 may include a set of virtual hardware devices, such as a virtual processor, a virtual memory, and a virtual disk. The at least one virtual machine 860 may include a guest operating system that has the capability to run one or more software applications, such as the RIC 840. The at least one virtual machine 860 may run the host operating system 866 upon which the container engine 864 may run. At least one virtual machine 860 may include one or more virtual processors. The container engine 864 may run on top of the host operating system 866 in order to run multiple isolated instances (or containers) on the same operating system kernel of the host operating system 866. Containers may perform virtualization at the operating system level and may provide a virtualized environment for running applications and their dependencies. The container engine 864 may acquire a container image and convert the container image into running processes. In some cases, the container engine 864 may group containers that make up an application into logical units (or pods). A pod may contain one or more containers and all containers in a pod may run on the same node in a cluster. Each pod may serve as a deployment unit for the cluster. Each pod may run a single instance of an application.

In order to scale an application horizontally, multiple instances of a pod may be run in parallel. A “replica” may refer to a unit of replication employed by a computing platform to provision or deprovision resources. Some computing platforms may run containers directly and therefore a container can include the unit of replication. Other computing platforms may wrap one or more containers into a pod and therefore a pod can include the unit of replication.

A replication controller may be used to ensure that a specified number of replicas of a pod are running at the same time. If less than the specified number of pods are running (e.g., due to a node failure or pod termination), then the replication controller may automatically replace a failed pod with a new pod. In some cases, the number of replicas may be dynamically adjusted based on a prior number of node failures. For example, if it is detected that a prior number of node failures for nodes in a cluster running a particular network slice has exceeded a threshold number of node failures, then the specified number of replicas may be increased (e.g., increased by one). Running multiple pod instances and keeping the specified number of replicas constant may prevent users from losing access to their application in the event that a particular pod fails or becomes inaccessible.

In some embodiments, a virtualized infrastructure manager not depicted may run on the RAN 620 in order to provide a centralized platform for managing a virtualized infrastructure for deploying various components of the RAN 620. The virtualized infrastructure manager may manage the provisioning of virtual machines, containers, and pods. The virtualized infrastructure manager may also manage a replication controller responsible for managing a number of pods. In some cases, the virtualized infrastructure manager may perform various virtualized infrastructure related tasks, such as cloning virtual machines, creating new virtual machines, monitoring the state of virtual machines, and facilitating backups of virtual machines.

The hardware-level components include at least one processor 870, at least one memory 872 operatively coupled with the at least one processor 870, and at least one disk 874. The at least one memory 872 can have stored therein processor-readable instructions when, when executed by the at least one processor 870, causes the at least one processor 870 to perform operations described herein. The components of the software layer may be run using the components of the hardware layer or executed using processor and storage components of the hardware layer. In some examples, at least one of the RIC 840, vCU 810, or vDU 820 may be run using the at least one processor 870, the at least one memory 872, and the at least one disk 874. In another example, at least one of the RIC 840, vCU 810, or vDU 820 may be run using a virtual processor and a virtual memory that are themselves executed or generated using the at least one processor 870, the at least one memory 872, and the at least one disk 874.

The at least one processor 870 may include one or more processing units, such as one or more CPUs and/or one or more graphics processing units (GPUs). The at least one memory 872 can include one or more types of memory (e.g., random-access memory (RAM), static RAM (SRAM), dynamic RAM (DRAM), read-only memory (ROM), electrically erasable programmable read-only memory (EEPROM), or flash memory). The at least one disk 874 can include a hard disk drive and/or a solid-state drive.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” determining,” “allocating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, from a user device associated with a user, a selection of at least one base service associated a network;
receiving a selection of at least one customized service for the user;
generating, using at least one artificial intelligence (AI) tool, a package for the user; and
deploying the package for the user.

2. The method of claim 1, further comprising:
determining whether a data platform is selected by the user; and
in response to determining that a data platform is selected by the user, enabling the data platform for the user.

3. The method of claim 1, wherein the at least one base service comprises at least one of: a device registration service, a test simulation service, or a network simulation service.

4. The method of claim 1, wherein the at least one customized service comprises at least one of a data quality service or an extract, transform, load (ETL) service.

5. The method of claim 1, wherein the at least one customized service comprises an artificial intelligence service to implement one or more machine learning models to assess at least one of: system requirements, validation of inputs and outputs, generation of downloadable files, or generation of packages to be deployed.

6. The method of claim 1, wherein the at least one customized service comprises a knowledge graph generation service to generate a personalized knowledge graph for the user.

7. The method of claim 6, wherein the personalized knowledge graph is a subgraph of a knowledge graph.

8. The method of claim 1, wherein generating the package for the user comprises generating the package for the user via Infrastructure as Code.

9. The method of claim 1, wherein generating the package for the user comprises generating the package for the user via a user interface.

10. The method of claim 1, wherein the network comprises a cloud-native network.

11. A system comprising:
a memory; and
a processing device, operatively coupled with the memory, to:
receive, from a user device associated with a user, a selection of at least one base service associated a network;
receive a selection of at least one customized service for the user;
generating, using at least one artificial intelligence (AI) tool, a package for the user; and
deploy the package for the user.

12. The system of claim 11, wherein the processing device is further to:
determine whether a data platform is selected by the user; and
in response to determining that a data platform is selected by the user, enable the data platform for the user.

13. The system of claim 11, wherein the at least one base service comprises at least one of: a device registration service, a test simulation service, or a network simulation service.

14. The system of claim 11, wherein the at least one customized service comprises at least one of a data quality service or an extract, transform, load (ETL) service.

15. The system of claim 11, wherein the at least one customized service comprises an artificial intelligence service to implement one or more machine learning models to assess at least one of: system requirements, validation of inputs and outputs, generation of downloadable files, or generation of packages to be deployed.

16. The system of claim 11, wherein the at least one customized service comprises a knowledge graph generation service to generate a personalized knowledge graph for the user.

17. The system of claim 16, wherein the personalized knowledge graph is a subgraph of a knowledge graph.

18. The system of claim 11, wherein, to generate the package for the user, the processing device is to generate the package for the user via Infrastructure as Code.

19. The system of claim 11, wherein, to generate the package for the user, the processing device is to generate the package for the user via a user interface.

20. The system of claim 11, wherein the network comprises a cloud-native network.
